(19) United States
(12) Patent Application Publication
(10) Pub. No.: US 2008/0219504 A1
(43) Pub. Date: Sep. 11, 2008

(54) AUTOMATIC MEASUREMENT OF ADVERTISING EFFECTIVENESS

(76) Inventors: Henry W. Adams, Evanston, IL (US); Marvin S. White, San Carlos, CA (US); Richard H. Cavallaro, Mountain View, CA (US); Rand Pendleton, Santa Cruz, CA (US)

Correspondence Address: VIERRA MAGEN MARCUS & DENIRO LLP, 575 MARKET STREET SUITE 2500, SAN FRANCISCO, CA, 94105, US

(21) Appl. No.: 12/041,918

(22) Filed: Mar. 4, 2008

Related U.S. Application Data
(60) Provisional application No. 60/893,119, filed on Mar. 5, 2007.

(51) Int. Cl. G06K 9/00

(52) U.S. Cl. 382/103

(57) ABSTRACT

An automated system for measuring information about a target image in a video is described. One embodiment includes receiving a set of one or more video images for the video, automatically finding the target image in at least a subset of the video images, determining one or more statistics regarding the target image being in the video, and reporting the one or more statistics.

### CLAIM OF PRIORITY

This application claims priority to Provisional Patent Application No. 60/893,119, filed on Mar. 5, 2007.

### BACKGROUND OF THE INVENTION

### Description of the Related Art

Television broadcast advertisers pay for airing of their advertisements, products or logos during a program broadcast. It is common to adjust the amount paid for in-program sponsorships according to measurements of the time the advertisements, products or logos are on air. Such measurements are often done by people reviewing a recording of a broadcast and using a stop watch to measure time on air. This method is error prone and captures only a subset of information relevant to the effectiveness of the advertisement or sponsorship.

### SUMMARY OF THE INVENTION

The technology described herein provides a more accurate, timely and informative measurement of advertising and sponsorship effectiveness. Instead of a person manually reviewing a recording and looking for instances of the desired advertisement, product, logo or other image appearing, the process is performed automatically by a computing system. One embodiment includes an automatic machine implemented method for measuring statistics about target images. The target images can be images of advertisements, products, logos, etc. Other types of images can also be target images.

One embodiment includes a machine implemented method for measuring information about a target image in a video. The method comprises receiving a set of one or more video images for the video, automatically finding the target image in at least a subset of the video images, determining one or more statistics regarding the target image being in the video, and reporting the one or more statistics.

One embodiment includes receiving a set of video images for the video, automatically finding the target images in at least a subset of the video images, determining separate sets of statistics for each target relating to the respective target image being in the video, and reporting about the sets of statistics.

One embodiment includes one or more processor readable storage devices having processor readable code stored on the one or more processor readable storage devices. The processor readable code programs one or more processors to perform a method comprising receiving a particular video image from a video of an event, automatically finding the target image in the particular video image, determining one or more statistics regarding the target image being in the particular video image, and reporting the one or more statistics.

One embodiment includes an apparatus that measures information about a target image in a video. The apparatus comprises a communication interface that receives the video, a storage device that stores the received video, and a processor in communication with the storage device and the communication interface. The processor finds the target image in the video and determines statistics about the target image being in the video.

In some implementations the processor accesses data about one or more positions of the target image in one or more previous video images and searches for the target image in a particular video image using the data about one or more positions of the target image in the one or more previous video images to restrict the searching. In some implementations, the processor finds the target image based on recognizing the target image in a particular video image and based on using camera sensor data.

### BRIEF DESCRIPTION OF THE DRAWINGS

FIG. 1 is a block diagram of one embodiment of a system for implementing the technology described herein.

FIG. 2 is a block diagram of one embodiment of a system for implementing the technology described herein.

FIG. 3 is a block diagram of one embodiment of a system for implementing the technology described herein.

FIG. 4 is a flowchart describing one embodiment of a process for implementing the technology described herein.

FIG. 5 us a flowchart describing one embodiment of a process for finding a target image in a video image.

### DETAILED DESCRIPTION

Instead of a person reviewing a recording and looking for instances of the target image appearing in the recording, the system uses image recognition to automatically measure statistics about a target image in a video. The system detects any appearance of the target image, makes one or more measurements related to the appearance of the target image, and relates the measurements to other relevant facts or measurements (such as program rating). Some of the measurements made include duration that the advertisement is viewable; percentage (or similar measure) of screen devoted to the advertisement, contrast (or similar measure of relative prominence); effective visibility based on angle of presentation, focus, general legibility, obscuration; and time of the appearance with respect to the show (for example, in a sporting event the quarter, period, play or other designation of time). With the technology described herein, these measurements can be made in real time and used not only for adjusting subsequent payment but also for making in-program adjustments such as adding additional air time.

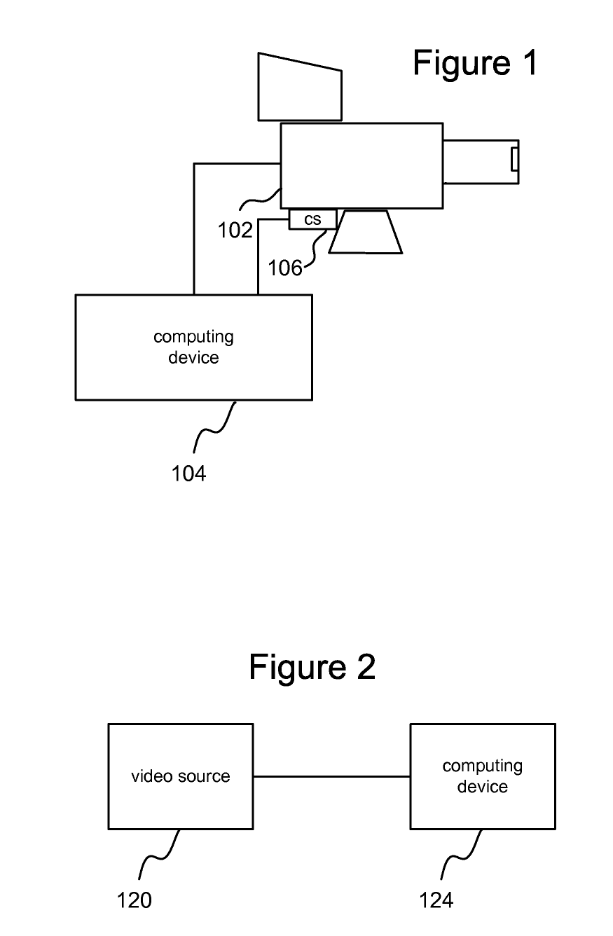

FIG. 1 is a block diagram of components for implementing a system that measures statistics about one or more targets images in a video. FIG. 1 shows a camera 102 which captures video and provides that video to computing device 104. Camera 102 can be any camera known in the art that can output video. The video can be in any suitable format known in the art. Computing device 104 can be a standard desktop computer, laptop computer, main frame computer device, super computer, or computer specialized for video processing. Other types of computing devices can also be used. In one embodiment, computing device 104 includes a special communication interface for receiving video from camera 102. For example, computing device 104 can include a video capture board. In other embodiments, the video can be provided to computing device 104 via other communication interfaces including communication over a LAN, WAN, USB port, wireless link, etc. No particular means for communicating the video from camera 102 to computing device 104 is necessary.

FIG. 1 also shows camera sensors 106 providing camera sensor data to computing device 104 via a LAN, WAN, USB port, serial port, parallel port, wireless link, etc. The camera sensors measure information about the camera orientation, focal length, position, focus, etc. This information can be used to determine the field of view of the camera. One example set of camera sensors includes an optical shaft encoder to measure pan of camera 102 on its tripod; an optical shaft encoder to measure tilt of camera 102 on its tripod; a set of inclinometers that measure attitude of the camera; and electronics for sensing the position of the camera's zoom lens, 2× extender, and focus. Other types of sensors can also be used.

In some embodiments, prior to operating the system that includes camera sensors, the system can be registered. Registration, a technology known by those skilled in the art, is the process of defining how to interpret data from a sensor and/or to ascertain data variables for operating the system. The camera sensors described above output data, for example, related to parameters such as position and orientation. Since some parameters such as position and orientation are relative, the system needs a reference from which to determine these parameters. Thus, in order to be able to use camera sensor data, the system needs to know how to interpret the data to make use of the information. Typically, registration includes pointing the instrumented cameras at known locations and solving for unknown variables used in matrices and other mathematics. More details of how to register the system can be found in U.S. Pat. No. 5,862,517; U.S. Pat. No. 6,229,550; and U.S. Pat. No. 5,912,700. all of which are incorporated herein by reference in their entirety.

FIG. 2 provides another embodiment of a system for measuring statistics related to target images in a video. FIG. 2 shows a video source 120, which can be any means for providing video. For example, video source 120 can be a camera, digital video recorder, videotape machine, DVD player, computer, database system, Internet, cable box, set top box, satellite television provider, etc. No particular type of video source is necessary. The output of the video source 120 is provided to computing device 124 (which is similar to computing device 104). Thus, the video that is processed according to the technology described herein can be live video (processed in real time), previously recorded video, animation, or other computer generated video.

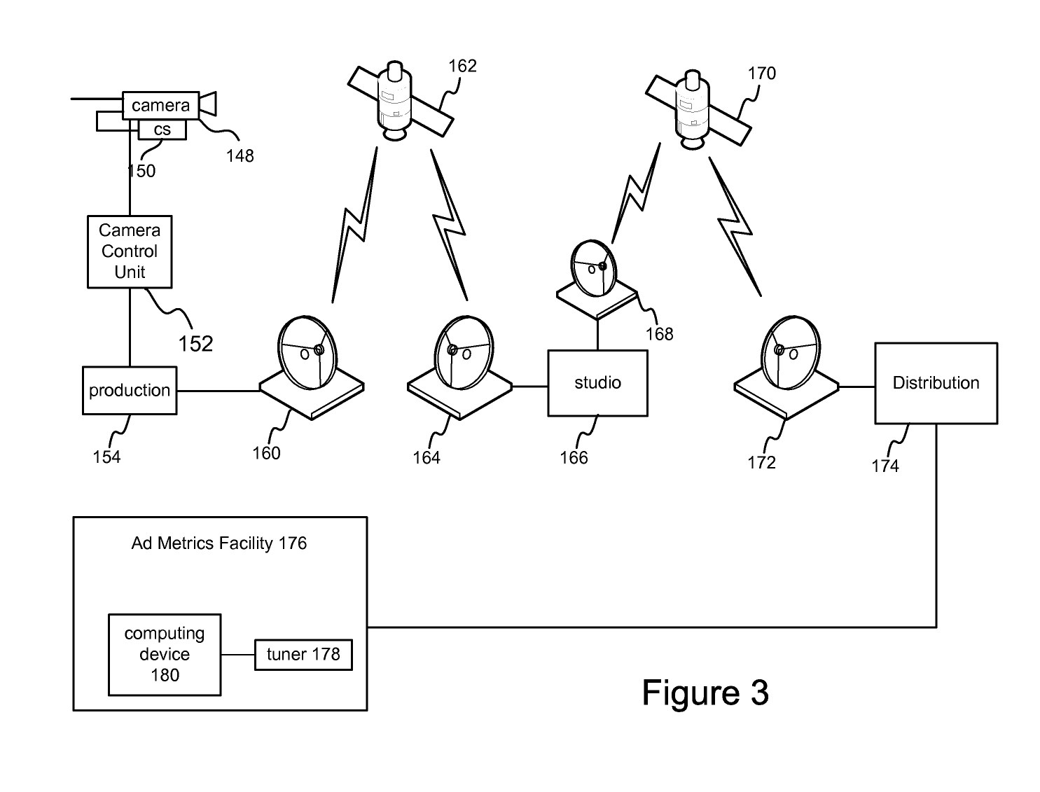

FIG. 3 provides another embodiment of a system for measuring statistics about target images in a video. FIG. 3 shows a camera 148 which can be located at a live event, such as a sporting event, talk show, concert, news show, debate, etc. Camera 148 will capture video of the live event for processing, as discussed herein. Camera 148 includes an associated set of camera sensors (CS) 150.

In some embodiments, there can be multiple cameras, each (or a subset) with its own set of camera sensors. In such an embodiment, the system will need some type of mechanism for determining which camera has been tallied for broadcast so the system will use the appropriate set of camera sensor data. In one embodiment, video from each camera can include a marker in the vertical blanking interval, Vertical ANCillary (VANC) or other associated data to indicate which camera the video is from. Similar means may be used to deliver the camera sensor data to the computing device. In other embodiments, the system can compare the received video image to a video image from all cameras at the event and determine which camera the video is from. Other means of determining tally can also be used.

The information from the camera sensors is encoded on an audio signal of camera 148 and sent down one of the microphone channels from camera 148 to camera control unit 152. In other embodiments, the data from the camera sensors can be sent to camera control unit 152 by another communication means. No particular communication means is necessary. Camera control unit 152 also receives the video from camera 148 and inserts a time code into the video. For example, time codes could be inserted into the vertical blanking interval of the video or coded into another part of the video. Alternatively, camera control unit 152 can transmit the video to a VITC inserter and the VITC inserter will add the time code to the video. Similarly, the camera sensor data may be encoded into the video stream downstream of the CCU.

The output of camera control unit 152, including the video and the microphone channel, are sent to a production truck (or other type of production center) 154. If the camera control unit sends the video to a VITC inserter, the VITC inserter would add the time code and send its output to production truck 154. In production truck 154, the show is produced for broadcast.

The produced video can include images of an advertisement that is also visible at the event. For example, if the event being filmed is a baseball game, then the video could include images of advertisements on a fence behind home plate. If the event being captured in the video is an automobile race, the video may include images of advertisements on race cars

The produced video can also include advertisements that are inserted into video, but do not appear at the actual game. It is known to add virtual insertions in proper perspective and orientation into the video of sporting events so that the virtual insertions appear in the video to be part of the underlying scene. For example, advertisements are added to the video image of a grass field (or other surface) so that the advertisement appears to the television viewer to be painted on the grass field; however, spectators at the event cannot see these advertisements because they do not exist in the real world.

Video can also include advertisements that are added to the video as overlays. These are images that are added on top of the video and may not be in proper perspective or orientation in relation to the underlying video.

Product placements are also common. For example, products (e.g., a branded bottle of a beverage or a particular brand of snack food) may be purposefully captured in the video as part of an agreement with the manufacturer or seller of the products.

The produced video is provided to satellite transmitter 160, which transmits the video to satellite receiver 164 via satellite 162. The video received at receiver 164 is provided to studio 166 which can further produce or edit the video (optional). The video from studio 166 is provided to satellite transmitter 168, which transmits the video to receiver 172 via satellite 170 (which can be the same or different from satellite 162). The video received at satellite receiver 172 is provided to distribution entity 174. Distribution entity 174 can be a satellite TV provider, cable TV provider, Internet video provider, or other provider of television/video content. That content is then broadcast or otherwise distributed (publicly or privately) using means known in the art such as cables, television airwaves, satellites, etc. As part of the distribution, the video is provided to an advertisement Metrics Facility 176 via any of the means discussed above or via a private connection. Advertisement Metrics Facility 176 includes a tuner 178 for receiving the video/television content from distribution entity 174. Tuner 178 will tune the appropriate television/video and provide that video to computing device 180 (which is similar to computing device 104. Tuner 178, which is optional, can be used to tune and/or demodulate the appropriate video from modulated signal containing one or more video streams or broadcasts. In one embodiment, tuner 178 can be part of a television, videotape player, DVD player, computer, etc.

In one embodiment, production center 154, studio 166 or another entity can insert the camera sensor data into the video signal. In one example, the camera sensor data is inserted into the vertical blanking interval. Computing device 180 can then access the camera sensor data from the video signal. In another embodiment, production center 154, studio 166 or another entity can transmit the camera sensor data to computing device 180 via the Internet, LAN or other communication means.

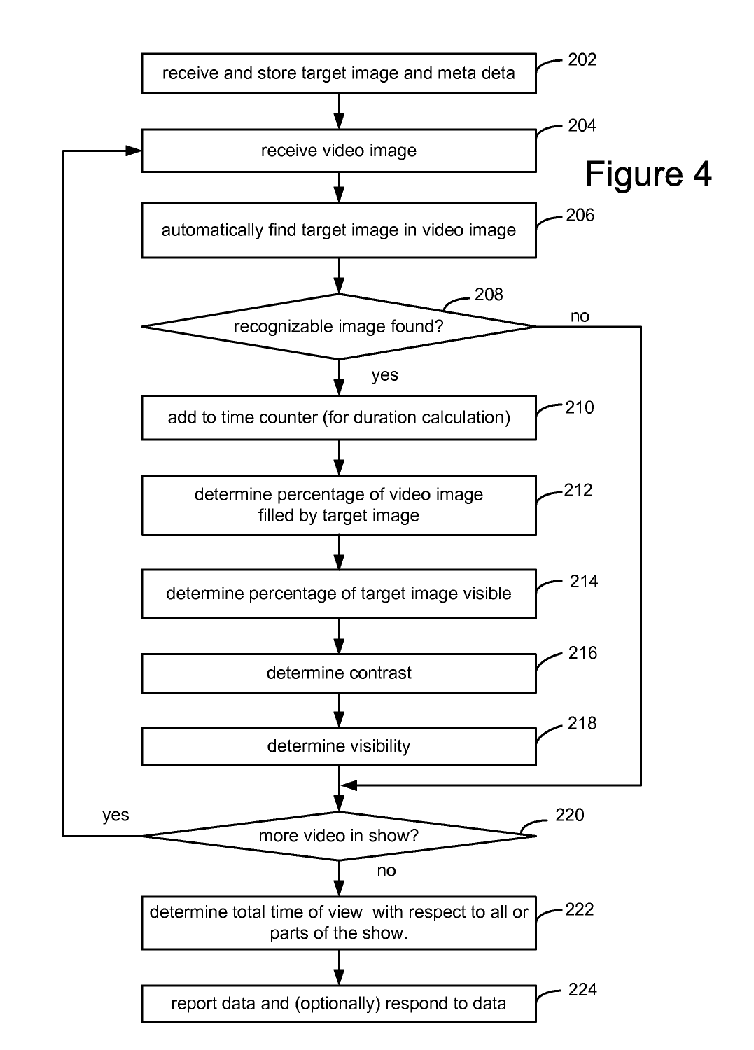

FIG. 4 is a flow chart that can be performed by computing device 104, computing device 124, computing device 180 or other suitable computing device. The process of FIG. 4 is an automatic method of determining statistics (e.g., time of exposure, percentage of target exposed, amount of video image displaying target, contrast, visibility, etc.) about a target image (e.g. advertisement, logo, product, etc.) in a video image (television broadcast or other type of video image).

In one embodiment, the computing devices discussed above (104, 124, 180) will include one or more processors, one or more computer readable storage devices (e.g. main memory, hard drive, DVD drive, flash memory, etc.) in communication with the processors and one or more communication interfaces (e.g. network card, modem, wireless communication means, monitor, printer, keyboard, mouse, pointing device, . . . ) in communication with the processors. Software stored on one or more of the computer readable storage devices will be executed by the one or more processors to perform the method of FIG. 4 in an automatic fashion.

In step 202 of FIG. 4, the computing device will receive and store one or more target image(s) and metadata for those target images. The target image will be an image of the advertisement, logo, product, etc. For example, the target image can be a JPG file, TIFF file, or other format. The metadata can be any information for that target image. In one embodiment, metadata could include a real world location of the original object that is the subject of the image in the real world. Metadata could also include other information, such as features in the image, characteristics of the image, image size, etc. In step 204, the system will receive a video image. In one embodiment, the video image received can be a field of video. In another embodiment, the video image received can be a frame of video. Other types of video images can also be received.

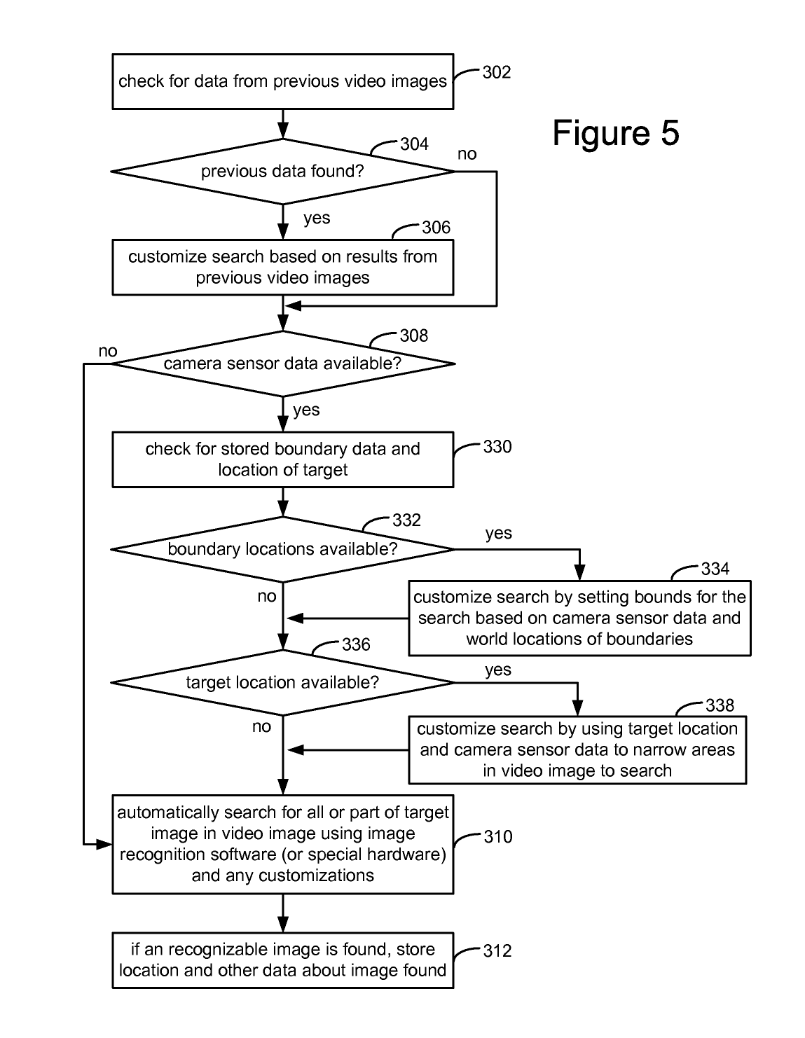

In step 206, the system will automatically find the target image (or some portion thereof) in the received video image. There are many different alternatives for finding a target image in a video image that are known in the art. In one embodiment, image recognition software is used to automatically find a target image in a video image. There are many different types of image recognition software that can perform this function suitably for the present technology. In other embodiments, specialized hardware can be used to recognize the target image in the video image. In other embodiments, the image recognition software can be used in conjunction with other technologies to find the target image. More information is discussed below with respect to FIG. 5.

If a recognizable target image is not found (step 208) in the video image, then the process skips to step 220 and determines whether there is any more video in the current program (or program segment). If so, the process loops back to step 204 and the next video image is received. While it is possible that a target image will be found in all video images of an event, it is more likely that the target image will be found in a subset of the total images depicting an event.

If a target image was found in the video image (step 208), then a time counter is incremented in step 210. In one embodiment, the time counter is used to count the number of frames (or fields or other types of images) that the target image appeared in. In some video formats, there are 30 frames per second and 60 fields per second. By counting the number of frames that depicted the target image, it can be determined how much time the target image was visible. In step 212, the computing device will determine the percentage of the video image that is covered by the target image. In step 214, the computing system determines what percentage of the target image is visible and unoccluded in the video. Depending on where the camera is pointing, the camera may capture only a portion of the target image. Because the computing device knows what the full target image looks like, it can determine what percentage of the target image is actually captured by the camera and depicted in the video.

In step 216, the contrast of the advertisement is determined. One method for computing contrast is to create histograms of the color and luma components of the video signal in the region of the logo and to create similar histograms corresponding to the video signal outside but near the logo and finally compute the difference in histograms for the two regions. Still another method is to use image processing tools such as edge finding in the region of the logo and compute the number, length and sharpness of the edges. Alternatively, one cold compare relevant metrics derived from the sample target image with the same metrics applied to the visible region(s) of the image in the current video frame. One example of this is computing the mean, variance, max and min of pixels located in the same relative region(s) of the visible image and the target image. Another example is to compute the output of various image processing edge detectors (Sobel being a common one known to practitioners) on known positions of the found image and the target image.

In step 218, the system determines the effective visibility of the target image in the video based on angle of presentation, focus and/or general legibility.

After step 218, the computing device determines if there is any more video in the show (step 220). If so, the process loops back to step 204. When there is no more video in the show that needs to be processed, then the computing system can determine the total time that the target was in view with respect to the entire length of the show or the length of a predefined segment of the show in step 222. For example, if the repeated application of step 210 determines that a target was visible for three thousand frames, then that target would have been visible for five minutes. If the show was a 30 minute television show, then the target was visible for 16.7 percent of the time. Step 222 may also include other calculations, such as metrics about exposure per segment (e.g. per quarter of a game), time of exposure at different percentages of the target image being visible (see step 214), average percentage of target image visible (see step 214), time of exposure at different percentages of the video image filled by the video image (see step 212), average percentage of video image filled by target image visible (see step 212), average contrast, etc.

In step 224, the data measured and/or calculated can be reported. In one embodiment, the data can be printed, stored in a file or other data structure, emailed, sent in a message, displayed on a monitor, displayed in a web page, etc. The data can be reported to a human, a software process, a computing device, internet site, database, etc. No one particular means for reporting is required.

In some embodiments, the system can respond to the data. For example, if the measurements and calculations are made in real time, they can be used for making in-program adjustments. Consider the situation where a customer paid for 16 minutes of air time and after the 3rd quarter of a four quarter basketball game, a logo has only appeared for 10 minutes. In this situation, the computing device can be programmed to alert and/or automatically configure production equipment 154 to display the logo for 6 minutes in the fourth quarter.

In some embodiments, the loop depicted in steps 204-220 of FIG. 4 is performed for every single frame or every single field in the video. In other embodiments, the loop is performed for a subset of fields or frames. Either way, it is contemplated that the process of FIG. 4 is used to find the target image in one or more video images of the event.

The process of FIG. 4 can be performed multiple times, concurrently or non-concurrently, for multiple target images. When performing the process of FIG. 4 concurrently for multiple images, the system will calculate a separate set of statistics for each target image. For example, steps 210-218 and 222 will be performed separately for each target image and the statistics such as exposure time, percentage of target visible, etc, will be calculated separately for each image. Note that when the process of FIG. 4 concurrently for multiple images, each target image can be processed at the exact same time or the target images can be processes serially in real time on live or pre-recorded video.

FIG. 5 is a flow chart describing one embodiment of a process for automatically finding a target image in a video image. For example, FIG. 5 provides more detail of one example implementation of step 206 of FIG. 4. The process of FIG. 5 finds the target image using image recognition techniques, or image recognition techniques in combination with camera sensor data (it is also contemplated that camera sensor data alone could be used without image recognition techniques) The process of FIG. 5 is performed by one of the computing devices described above, using software to program a processor and/or specialized hardware.

In step 302 of FIG. 5, the computing device will check for data from previous video images. In one embodiment, each time the computing device finds the target image in the video, the computing device will store that position of the target image. Using optical flow analysis known in the art, the system can use a set of previous positions of the target image and/or other recognizable patterns in the video to predict where the target image will be in future video images. Those predictions can be used to make it easier for image recognition software to find the image. For example, the image recognition can start looking for the image in the predicted location or the image recognition software can assume that the target image is somewhere within the neighborhood of the previous location and restrict its search (or start its search) in that neighborhood.

Another embodiment makes use of Scale-Invariant Feature Transform (SIFT), which is a computer vision technology that detects and describes local features in images. The detection and description of local image features can help in future object recognition. The SIFT features are local and based on the appearance of the object at particular interest points, and are invariant to image scale and rotation. They are also robust to changes in illumination, noise, and occlusion, as well as minor changes in viewpoint. In addition to these properties, they are highly distinctive, relatively easy to extract, allow for correct object identification with low probability of mismatch, and are easy to match against a large database of local features. In addition to object recognition, the SIFT features can be used for matching, which is useful for tracking. SIFT is known in the art. U.S. Pat. No. 6,711,293 provides one example of a discussion of SIFT. In sum, the SIFT technology can be used to identify certain features of the target image. The SIFT algorithm can be run prior to the process of FIG. 4 and the features identified by the SIFT algorithm can be stored as metadata in step 202 of FIG. 4 and used with the process of FIG. 5. Alternatively, the SIFT algorithm can be run for each video image and the data from each image is then stored for future images. In another alternative, SIFT can be used to periodically update the features stored.

In one embodiment, step 302 includes looking for previous SIFT data and/or previous target image position data. If any of that data is found (step 304), then the search by the image recognition software (to be performed below) can be customized based on the results from the data from previous images. As discussed above, the image recognition software can start from a past location, be limited to a subset of the target image, can use previously found features, etc. If no previous data was found (step 304), then step 306 will not be performed.

In step 308, it is determined whether any camera sensor data is available for the video image under consideration. As described above, camera sensor data is obtained for the camera and stored with the video images. The data can be stored in the video image or in a separate database that is indexed to the video image. That camera sensor data may indicate the pan position, tilt position, focus, zoom, etc. of the camera that captured the video image. That camera sensor data can be used to determine the field of view of the camera. Once the field of view is known, the system can use the field of view to improve the image recognition process. If no camera sensor data is available (step 308), then the process will skip to step 310 and perform the automatic search using the image recognition software.

If there is camera sensor data available for the particular video image under consideration (step 308), then the computing device will check to see if it has any boundary locations or target data is stored in its memory. Prior to an event, an operator may determine that there are portions of the environment where a target image could be and portions of the environment where the target image cannot be. For example, at a baseball game, the operator may determine that the target may only be on a fence or on the grass field. Thus, the operator can mark a boundary around the fence and the grass field that separates the fence and grass field from the rest of the environment. By storing one or more three dimensional locations of that boundary (e.g. four corners of a rectangle, points around a circle, or other indications of a boundary), the system will know where a target image can and cannot be. If there is boundary data available (step 332), then the system will convert those dimensional boundary locations (in one embodiment, three dimensional locations) to two dimensional positions in the video in step 334. Once the two dimensional positions in the video are determined for the boundary, the image recognition process performed later can be customized to only search within the boundary. In an alternative embodiment, the image recognition software can be customized to only search outside the boundary.

The three dimensional locations of the boundary are transformed to two dimensional positions in the video based on the camera sensor data using techniques known in the art. Examples of such techniques are described in the following U.S. Patent which are incorporated herein by reference: U.S. Pat. No. 5,912,700; U.S. Pat. No. 6,252,632; U.S. Pat. No. 5,917,553; U.S. Pat. No. 6,229,550; U.S. Pat. No. 6,965,397; and U.S. Pat. No. 7,075,556. If there are no boundary locations available (step 332), then step 334 is skipped.

In step 336, the computing system determines whether the target's real world location is stored. If the target is an image of an object that is actually at a location at the event or an image that is inserted virtually into the video at a location at the event, that location can have a set of coordinates (in one embodiment, three dimensional coordinates) that define where that location is in real world space. Those coordinates can be stored in the memory for the computing system. Using the camera sensor data discussed above, the computing system can transform those three dimensional coordinates (or other type of coordinates) to two dimensional positions in the video. In step 338, the system customizes the search for the target image by using that determined two dimensional position as a starting point for the image recognition software, or the image recognition software can be limited to search within a neighborhood of that position in the video image.

Note that in one embodiment, instead of using a real world location in steps 336 and 338, the computing system can store camera sensor values that correspond to the target image. These pre-stored camera sensor values are used to indicate that the camera is looking at the target image and predict where the target image should be in order to restrict where the image recognition software looks for the target image.

In step 310, the image recognition software will automatically search for all or part of the target image in the video image. Step 310 will be customized based on steps 306, 334, and/or 338, as appropriate (as discussed above). That is previous data, boundaries and real world locations are used to refine and restrict the image recognition process in order to speed up the process and increase the success rate. If any recognizable image is found (step 312), then the location of that image in the video is stored and other data about the image can also be stored (SIFT features, etc.).

In one embodiment, the target image will be a two dimensional image. The video will typically be in perspective based on the camera. The system can use the camera tally and camera sensors to predict the perspective of the target image as it appears in the video. This will help the image recognition software. Alternately, the system can memorize the perspective of an image in a given camera and know that it will be similar each time it appears.

Another embodiment of automatically finding a target image in the video can be performed using camera sensor data without image recognition. If the target is an image of an object that is actually at a location at the event or an image that is inserted virtually into the video at a location at the event, that location can have a set of coordinates (in one embodiment, three dimensional coordinates) that define where that location is in real world space. Those coordinates can be stored in the memory for the computing system. Using the camera sensor data discussed above, the computing system can transform those three dimensional coordinates (or other type of coordinates) to two dimensional positions in the video. The two dimensional positions in the video will represent the position of the target image in the video; therefore, if the transformation of the three dimensional coordinates results in a set of one or more two dimensional positions in the video, then it is concluded that the target image is found in the video.

In one embodiment, an operator can use a GUI to indicate when certain events occur, such as a scoring play or penalty. If a target image is found during the scoring play or penalty, then the amount of time that the target image is reported as being visibly can be augmented by a predetermined factor. For example, the system can double the value of exposure time during scoring plays.

In one embodiment, the system can change the exposure time based on how fast the camera is moving. If the camera is moving at a speed within a window of normal speeds, the exposure time is reported as measured. If the camera is moving faster then the window of normal speeds, the exposure time is reported as a fraction of the measure exposure time to account for the poor visibility. The speed of the camera movement can be determined based on the camera sensors.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

What is claimed is:

1. A machine implemented method for measuring information about a target image in a video, comprising:
receiving a set of video images for the video;
automatically finding the target image in at least a subset of the video images;
determining one or more statistics regarding the target image being in the video; and
reporting about the one or more statistics.

2. A method according to claim 1, wherein:
the determining one or more statistics includes determining total time the target image is in the video.

3. A method according to claim 1, wherein:
the determining one or more statistics includes determining time the target image is in the video during a predefined portion of an event depicted in the video.

4. A method according to claim 1, wherein:
the determining one or more statistics includes determining a percentage of the target image that is visible in the video.

5. A method according to claim 1, wherein:
the determining one or more statistics includes determining a percentage of the video that is filled by the target image.

6. A method according to claim 1, wherein:
the determining one or more statistics includes determining contrast information for the target image.

7. A method according to claim 1, wherein the automatically finding the target image comprises:
accessing data about one or more positions of the target image in one or more previous video images; and
performing image recognition in the subset of video images to find the target image and using the data about the one or more positions of the target image in one or more previous video images to limit the image recognition.

8. A method according to claim 1, wherein the automatically finding the target image comprises:
accessing data about one or more positions of the target image in one or more previous video images;
predicting a location in a current video image based on the one or more positions of the target image in the one or more previous video images;
searching for the target image in a neighborhood of the predicted location in the current video image.

9. A method according to claim 1, wherein the automatically finding the target image comprises:
accessing data about features of the target image, the data about the features is invariant to image scale and rotation; and
searching for and recognizing the features using the data about the features.

10. A method according to claim 1, wherein:
the automatically finding the target image is at least partially based on recognizing the target image in the subset of the set of video images; and
the automatically finding the target image is at least partially based on using camera sensor data.

11. A method according to claim 1, wherein:
the video is of an event; and
the automatically finding the target image includes:
accessing an indication of a boundary at the event,
accessing camera orientation data for a particular video image of the subset of video images,
determining a position of the boundary in the particular video image using the camera orientation data, and
searching for the target image in the particular video image, including using the position of the boundary to restrict the searching.

12. A method according to claim 1, wherein:
the video is of an event;
the target image corresponds to a real world location at the event;
the automatically finding the target image includes:
accessing camera orientation data for a particular video image of the subset of video images,
determining a position in the particular video image of the real world location using the camera orientation data, and
searching for the target image in the particular video image, including using the position in the particular video image of the real world location to restrict the searching.

13. A method according to claim 12, wherein:
the camera orientation data includes camera sensor data.

14. A method according to claim 1, wherein:
the determining includes calculating time of exposure of the target image in the video; and
the reporting includes adjusting exposure time based on what is occurring in the video.

15. A method according to claim 1, wherein:
the determining includes calculating time of exposure of the target image in the video;
the method includes determining rate of movement of the camera; and
the reporting includes adjusting exposure time based on the determined rate of movement of the camera.

16. A machine implemented method for measuring information about a target image in a video, comprising:
receiving a video image from the video;
automatically finding the target image in the video image;
determining one or more statistics regarding the target image being in the video image; and
reporting about the one or more statistics.

17. A method according to claim 16, further comprising:
determining cumulative time the target image is in the video.

18. A method according to claim 16, wherein:
the determining one or more statistics includes determining a percentage of the video that is filled by the target image.

19. One or more processor readable storage devices having processor readable code stored on the one or more processor readable storage devices, the processor readable code programs one or more processors to perform a method comprising:
receiving a particular video image from a video of an event;
automatically finding the target image in the particular video image;
determining one or more statistics regarding the target image being in the particular video image; and
reporting about the one or more statistics.

20. One or more processor readable storage devices according to claim 19, wherein the automatically finding the target image includes:
accessing data about one or more positions of the target image in one or more previous video images; and
searching for the target image in the particular video image, including using the data about one or more positions of the target image in one or more previous video images to restrict the searching.

21. One or more processor readable storage devices according to claim 19, wherein:
the automatically finding the target image is at least partially based on recognizing the target image in the particular video image; and
the automatically finding the target image is at least partially based on using camera sensor data to find the target image in the particular video image.

22. One or more processor readable storage devices according to claim 19, wherein the automatically finding the target image includes:
accessing data about one or more positions of the target image in one or more previous video images;
predicting a location in the particular video image based on the one or more positions of the target image in the one or more previous video images;
searching for the target image in a neighborhood of the predicted location in the particular video image.

23. One or more processor readable storage devices according to claim 19, wherein the automatically finding the target image includes:
accessing data about features of the target image, the data about the features is invariant to image scale and rotation; and
searching for and recognizing the features using the data about the features.

24. One or more processor readable storage devices according to claim 19, wherein the automatically finding the target image includes:
accessing an indication of a boundary at the event;
accessing camera orientation data for the particular video image;
determining a position of the boundary in the particular video image using the camera orientation data; and
searching for the target image in the particular video image, including using the position of the boundary to restrict the searching.

25. One or more processor readable storage devices according to claim 19, wherein:
the target image corresponds to a real world location at the event; and
the automatically finding the target image includes:
accessing camera orientation data for the particular video image,
determining a position in the particular video image of the real world location using the camera orientation data, and
searching for the target image in the particular video image, including using the position in the particular video image of the real world location to restrict the searching.

26. An apparatus that measures information about a target image in a video, comprising:
a communication interface, the communication interface receives the video;
a storage device, the storage device stores the received video; and
a processor in communication with the storage device and the communication interface, the processor finds the target image in the video and determines statistics about the target image being in the video.

27. An apparatus according to claim 26, wherein:
the processor accesses data about one or more positions of the target image in one or more previous video images and searches for the target image in a current video image using the data about one or more positions of the target image in the one or more previous video images to restrict the searching.

28. An apparatus according to claim 26, wherein:
the processor finds the target image based on recognizing the target image in a particular video image and based on using camera sensor data.

29. An apparatus according to claim 26, wherein:
the processor accesses data about one or more positions of the target image in one or more previous video images and predicts a location in a current video image based on the one or more positions of the target image in the one or more previous video images; and
the processor searches for the target image in a neighborhood of the predicted location in the current video image.

30. An apparatus according to claim 26, wherein:
the processor accesses data about features of the target image, the data about the features is invariant to image scale and rotation; and
the processor searches for and recognizes the features using the data about the features.

31. An apparatus according to claim 26, wherein:
the processor accesses an indication of a boundary at the event;
the processor accesses camera orientation data for a particular video image;
the processor determines a position of the boundary in the particular video image using the camera orientation data; and
the processor searches for the target image in the particular video image, including using the position of the boundary to restrict the searching.

32. An apparatus according to claim 26, wherein:
the target image corresponds to a real world location at the event;
the processor accesses camera orientation data for a particular video image;
the processor determines a position in the particular video image of the real world location using the camera orientation data; and
the processor searches for the target image in the particular video image, including using the position in the particular video image of the real world location to restrict the searching.

33. A machine implemented method for measuring information about target images in a video, comprising:
receiving a set of video images for the video;
automatically finding the target images in at least a subset of the video images;
determining separate sets of statistics for each target relating to the respective target image being in the video; and
reporting about the sets of statistics.
